(19) United States
(12) Patent Application Publication
(10) Pub. No.: US 2026/0336720 A1
(43) Pub. Date: Oct. 29, 2026

(54) COUPLING STRUCTURE OF VEHICLE

(71) Applicants: Hyundai Motor Company, Seoul (KR); Kia Corporation, Seoul (KR)

(72) Inventor: Su In Park, Hwaseong (KR)

(21) Appl. No.: 19/537,755

(22) Filed: Feb. 12, 2026

(30) Foreign Application Priority Data
Apr. 28, 2025 (KR) 10-2025-0055407

(51) Int. Cl. B62D 27/06

(52) U.S. Cl. CPC B62D 27/06

(57) ABSTRACT

A coupling structure of a vehicle may comprise an underbody and an upper body coupled to the upper portion of the underbody, wherein he underbody and the upper body are fastened or unfastened by a body fastening part comprising a bracket, a switching magnet built into the bracket and operating to fasten or unfasten the upper body and the under body according to a change in the position of the polarity, a fastening switch connected to the switching magnet and rotating to change a range of magnetic force lines formed by the switching magnet, a motor that is shaft-connected to the fastening switch and provides a power to rotate the fastening switch, and a spring having two ends connected to two ends of the fastening switch and applies a tension to the fastening switch to enable a smooth rotation and fixation of the fastening switch.

### CROSS-REFERENCE TO RELATED APPLICATION

This application claims, under 35 U.S.C. §119(a), the benefit of Korean Patent Application No. 10-2025-0055407, filed Apr. 28, 2025, with the Korean Intellectual Property Office, the entire contents of which are incorporated herein by reference.

### BACKGROUND

### a. Technical Field

The present disclosure relates to a coupling structure of a vehicle and, more specifically, to a coupling structure of a vehicle configured to attach and detach an upper body of an unmanned delivery vehicle formed by combining the upper body and an under body.

### b. Background

The vehicle industry has recently introduced the new concept of future mobility visions for realizing a human-centered dynamic future city. One of these future mobility solutions is a purpose-built vehicle (PBV) as a purpose-based mobility.

An example of a PBV vehicle is an eco-friendly vehicle based on an electric vehicle (EV). These PBV vehicles may be configured to provide users with a variety of customized services while traveling from their starting point to their destination in an unmanned or manned autonomous manner.

Such PBV vehicles may comprise a cab-type driving module that is equipped with a driving device and capable of performing autonomous driving, and a space module that is combined with the driving module and used for a cargo transport, a passenger transport, a home office use, etc.

These driving modules and space modules may be configured as an underbody and an upper body that is connected to the upper part of the underbody and is movable together by a driving torque of the underbody, respectively. The underbody and upper body may be provided with a magnet at corresponding locations so that they may be coupled and separated from each other by applying and releasing a magnetic force. When the magnetic force is released, the underbody may be configured to drive independently.

However, if a lifting magnet using a conventional electromagnet is applied as the magnet for attaching and detaching the underbody and upper body, an attachment and detachment process is complicated as it requires multiple steps, and there is a risk of detachment by an external force due to a presence of a protruding magnetic on/off switch. Furthermore, there is a concern that the vehicle's appearance may be damaged. In addition, since a current must be continuously applied to maintain the magnetism of the electromagnet, an energy loss is large, and when the starting of the vehicle is turned off, it is difficult to maintain the fastening force between the underbody and the upper body due to the loss of the magnetism.

The above information disclosed in this Background section is only for enhancement of understanding of the background of the present disclosure, and therefore it may contain information that does not form the related art that is already known to one having ordinary skill in the art.

### SUMMARY

Accordingly, according to an exemplary embodiment of the present disclosure, when attaching or detaching a driving module and a space module in a PBV vehicle, a coupling structure of a vehicle is provided that may be simplified, reduce an energy consumption, and improve a robustness of a fastening by applying a switching magnet and a coupling switch that changes the range of the magnetic force formed by the switching magnet.

A coupling structure of a vehicle according to an embodiment includes an underbody constituting a driving module and an upper body coupled to the upper portion of the underbody and constituting a space module, wherein he underbody and the upper body are fastened or unfastened by a body fastening part, and the body fastening part includes a bracket provided at a corner portion of the lower portion of the upper body; a switching magnet built into the bracket and operating to fasten or unfasten the upper body and the under body according to a change in the position of the polarity; a fastening switch connected to the switching magnet and rotating to change a range of magnetic force lines formed by the switching magnet; a motor that is shaft-connected to the fastening switch and provides a power to rotate the fastening switch; and a spring having two ends connected to two ends of the fastening switch and applies a tension to the fastening switch to enable a smooth rotation and fixation of the fastening switch.

The switching magnet may include an upper switching magnet arranged in a horizontal direction with respect to the underbody and having opposite polarities on one side and the other side; and a lower switching magnet arranged to form a gap with the upper switching magnet, having opposite polarities on one side and the other side, and rotates on an axis by the driving of the motor.

The upper switching magnet may be formed in a plate shape, and the lower switching magnet may be formed in a cylindrical shape.

The upper switching magnet may be formed of a plurality of plate shapes that form a gap between each other.

The rotation axis of the motor may be coaxially connected to the rotation axis of the lower switching magnet.

The rotation axis of the motor may further include a motor gear coaxially connected to the rotational axis of the motor and coupled to the switching magnet to rotate the switching magnet.

The fastening switch may include an upper fastening switch having one end connected to one end of the spring and the other end connected to the rotational shaft of the motor so as to rotate in synchronization with the driving of the motor; and a lower fastening switch having one end overlapping and connected to the other end of the upper fastening switch and the other end connected to the other end of the spring, and the distance between one end of the upper fastening switch and the other end of the lower fastening switch may change as they rotate around a portion where the other end of the upper fastening switch and one end of the lower fastening switch overlap.

The other end of the upper fastening switch and one end of the lower fastening switch may be coupled by a rotary pin, and the rotary pin is coaxially connected to the rotation axis of the lower switching magnet.

When the distance between one end of the upper fastening switch and the other end of the lower fastening switch rotate to be increased, the spring is tensioned, and a restoring force may be applied so that the distance between one end of the upper fastening switch and the other end of the lower fastening switch is reduced by the elasticity of the spring.

The polarity of the lower switching magnet may be formed to be larger than the polarity of the upper switching magnet.

The polarities of the upper switching magnet and the lower switching magnet facing upward and downward may be formed opposite to each other while the distance between one end of the upper fastening switch and the other end of the lower fastening switch is rotate toward one side as close as possible.

The magnetic force lines of the switching magnet may be formed only within the upper body when the polarities of the upper switching magnet and the lower switching magnet facing each other are formed in opposite directions.

The polarities of the upper switching magnet and the lower switching magnet facing upward and downward may be formed to be the same while the distance between one end of the upper fastening switch and the other end of the lower fastening switch is rotated toward the other side as close as possible.

When the polarities of the upper switching magnet and the lower switching magnet facing each other are formed to be the same, the magnetic force lines of the switching magnet may be formed to extend from the side of the upper body to the under body.

In the underbody portion corresponding to the body fastening portion, a paramagnetic iron plate on which an attractive force may be applied by the magnetic force lines of the switching magnet is provided.

The vehicle may be placed inside the placement station in a state where the underbody and upper body are fastened, the upper body may be fixedly mounted on the inside of the placement station while the underbody and upper body are separated from each other, and the underbody may be detached from the placement station.

When the upper body is placed and fixed on the inside of the placement station, a PBV body fixing protrusion may protrude toward the upper body on the inside of the placement station, and the PBV body fixing protrusion may be inserted into an upper body fixing groove formed corresponding to the side of the upper body.

The lower surface of the upper body may be provided with a plurality of stretcher legs that operate to be folded or unfolded, with the underbody and the upper body fastened, the stretcher leg is folded, the stretcher legs may be spread out to support the upper body on the ground when the underbody is detached from the placement station.

The stretcher leg may include a first leg having one end connected to the lower surface of the upper body so as to rotate in a direction perpendicular to the ground, a second leg having one end connected to the lower surface of the upper body so as to rotate in the opposite direction to the rotation direction of the first leg, and a first connecting leg that connects the other end of the first leg and the other end of the second leg so that the stretcher leg may be folded or unfolded when the first leg and the second leg are rotated.

The stretcher leg may further include a second connecting leg connecting the other ends of the first legs provided on the lower surfaces on both sides of the upper body.

In this way, according to an exemplary embodiment of the present disclosure, in a body swap station of an unmanned delivery vehicle, by applying a lifting process of the upper body using the switching magnet when the fastening force between the upper body and the underbody of the vehicle is released, the swap process of the underbody may be performed quickly and easily.

Additionally, compared to a mechanical fastening between the upper body and the underbody, a noise during the fastening may be reduced and a robustness may be secured.

In addition, by changing the magnetic field lines of the switching magnet through the rotational motion of the fastening switch using the motor to utilize the principle of applying and releasing the attractive force, there is the effect of reducing the power consumption compared to when using an electromagnet.

In addition, by applying the foldable stretcher leg installed at the lower part of the upper body, the stable placement of the upper body on the inside of the placement station is possible during the swap process of the upper body and the under body.

According to an aspect of the present disclosure, a coupling structure of a vehicle is provided. The coupling structure may comprise an underbody constituting a driving module, an upper body coupled to an upper portion of the underbody and constituting a space module, and a body fastening part configured to fasten or unfasten the underbody and the upper body. The body fastening part may comprise a bracket provided at a corner portion of the lower portion of the upper body, a switching magnet built into the bracket and configured to fasten or unfasten the upper body and the under body according to a change in a position of polarity, a fastening switch connected to the switching magnet and configured to rotate to change a range of magnetic force lines formed by the switching magnet, a motor, shaft-connected to the fastening switch, configured to provide power to rotate the fastening switch, and a spring having two ends connected to two ends of the fastening switch and configured to apply a tension to the fastening switch to enable a smooth rotation and fixation of the fastening switch.

According to an exemplary embodiment, the switching magnet may comprise an upper switching magnet arranged in a horizontal direction with respect to the underbody and having opposite polarities on one side and another side, and a lower switching magnet arranged to form a gap with the upper switching magnet, having opposite polarities on one side and another side, and configured to rotate on an axis by the driving of the motor.

According to an exemplary embodiment, the upper switching magnet may be formed in a plate shape, and the lower switching magnet may be formed in a cylindrical shape.

According to an exemplary embodiment, the upper switching magnet may be formed of a plurality of plate shapes that form a gap between each other.

According to an exemplary embodiment, the rotation axis of the motor may be coaxially connected to the rotation axis of the lower switching magnet.

According to an exemplary embodiment, the rotation axis of the motor may further comprise a motor gear coaxially connected to the rotational axis of the motor and coupled to the switching magnet to rotate the switching magnet.

According to an exemplary embodiment, the fastening switch may comprise an upper fastening switch having one end connected to one end of the spring and the other end connected to the rotational shaft of the motor so as to rotate in synchronization with the driving of the motor, and a lower fastening switch having one end overlapping and connected to the other end of the upper fastening switch and the other end connected to the other end of the spring. A distance between one end of the upper fastening switch and another end of the lower fastening switch may change as they rotate around a portion where the other end of the upper fastening switch and one end of the lower fastening switch overlap.

According to an exemplary embodiment, the other end of the upper fastening switch and one end of the lower fastening switch may be coupled by a rotary pin, and the rotary pin may be coaxially connected to the rotation axis of the lower switching magnet.

According to an exemplary embodiment, when the distance between one end of the upper fastening switch and the other end of the lower fastening switch rotate to be increased, the spring may be tensioned, and, when a restoring force is applied, the distance between one end of the upper fastening switch and the other end of the lower fastening switch may be reduced by an elasticity of the spring.

According to an exemplary embodiment, a polarity of the lower switching magnet may be formed to be larger than a polarity of the upper switching magnet.

According to an exemplary embodiment, the polarities of the upper switching magnet and the lower switching magnet may be facing upward and downward and may be formed opposite to each other while the distance between one end of the upper fastening switch and the other end of the lower fastening switch is rotated toward one side as close as possible.

According to an exemplary embodiment, the magnetic force lines of the switching magnet may be formed only within the upper body when the polarities of the upper switching magnet and the lower switching magnet facing each other are formed in opposite directions.

According to an exemplary embodiment, the polarities of the upper switching magnet and the lower switching magnet, facing upward and downward, may be formed to be the same while the distance between one end of the upper fastening switch and the other end of the lower fastening switch is rotated toward the other side as close as possible.

According to an exemplary embodiment, when the polarities of the upper switching magnet and the lower switching magnet facing each other are formed to be the same, the magnetic force lines of the switching magnet may be formed to extend from the side of the upper body to the under body, and, in the underbody portion corresponding to the body fastening portion, a paramagnetic iron plate on which an attractive force is applied by the magnetic force lines of the switching magnet may be provided.

According to an exemplary embodiment, the vehicle may be placed inside the placement station in a state where the underbody and upper body are fastened, and the upper body may be fixedly mounted on the inside of the placement station while the underbody and upper body are separated from each other, and the underbody is detached from the placement station.

According to an exemplary embodiment, when the upper body is placed and fixed on the inside of the placement station, a PBV body fixing protrusion may protrude toward the upper body on the inside of the placement station, and the PBV body fixing protrusion may be inserted into an upper body fixing groove formed corresponding to the side of the upper body.

According to an exemplary embodiment, the lower surface of the upper body may be provided with a plurality of stretcher legs that operate to be folded or unfolded, with the underbody and the upper body fastened, the stretcher leg may be folded, and the stretcher legs may be spread out to support the upper body on the ground when the underbody is detached from the placement station.

According to an exemplary embodiment, the stretcher leg may comprise a first leg having one end connected to the lower surface of the upper body so as to rotate in a direction perpendicular to the ground, a second leg having one end connected to the lower surface of the upper body so as to rotate in the opposite direction to the rotation direction of the first leg, and a first connecting leg that connects the other end of the first leg and the other end of the second leg so that the stretcher leg may be folded or unfolded when the first leg and the second leg are rotated.

According to an exemplary embodiment, the stretcher leg may further comprise a second connecting leg connecting the other ends of the first legs provided on the lower surfaces on both sides of the upper body.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 illustrates a view showing a state in which a vehicle enters a placement station in a coupling structure of a vehicle, according to an exemplary embodiment of the present disclosure.

FIG. 2 illustrates a view showing a state in which a vehicle has completed entry into a placement station in a coupling structure of a vehicle, according to an exemplary embodiment of the present disclosure.

FIG. 3 illustrates a perspective view showing a body fastening part in a state where a magnetic force has disappeared, viewed from one side, in a coupling structure of a vehicle, according to an exemplary embodiment of the present disclosure.

FIG. 4 illustrates a perspective view showing a body fastening part in a state where the magnetic force has disappeared, as viewed from the other side, in a coupling structure of a vehicle, according to an exemplary embodiment of the present disclosure.

FIG. 5 illustrates a perspective view showing a body fastening part in a state where a magnetic force begins to be generated, as viewed from one side, in a coupling structure of a vehicle, according to an exemplary embodiment of the present disclosure.

FIG. 6 illustrates a perspective view showing a body fastening part in a state where magnetic force begins to be generated, as viewed from the other side, in a coupling structure of a vehicle, according to an exemplary embodiment of the present disclosure.

FIG. 7 illustrates a perspective view showing a body fastening part in a state where a magnetic force is generated, viewed from one side, in a coupling structure of a vehicle, according to an exemplary embodiment of the present disclosure.

FIG. 8 illustrates a perspective view showing a body fastening part in a state where magnetic force is generated, as viewed from the other side, in a coupling structure of a vehicle, according to an exemplary embodiment of the present disclosure.

FIG. 9 illustrates a view showing another example of a switching magnet included in a body fastening part in a coupling structure of a vehicle, according to an exemplary embodiment of the present disclosure.

FIG. 10 illustrates a perspective view showing a state in which a vehicle, in which an upper body is coupled to an underbody by a body fastening part in a state in which a magnetic force is generated, enters a placement station in a coupling structure of a vehicle, according to an exemplary embodiment of the present disclosure.

FIG. 11 illustrates a plan view showing a state in which a vehicle, in which an upper body is coupled to an underbody by a body fastening part in a state in which a magnetic force is generated, enters a placement station, as viewed from above, in a coupling structure of a vehicle, according to an exemplary embodiment of the present disclosure.

FIG. 12 illustrates a perspective view showing a state in which a vehicle, in which an upper body is coupled to an underbody by a body fastening part in a state in which a magnetic force is generated, has entered a placement station in a coupling structure of a vehicle, according to an exemplary embodiment of the present disclosure.

FIG. 13 illustrates a plan view showing a state in which a vehicle, in which an upper body is connected to an underbody by a body fastening part in a state in which a magnetic force is generated, has entered a placement station, as viewed from above, in a coupling structure of a vehicle, according to an exemplary embodiment of the present disclosure.

FIG. 14 illustrates a perspective view showing a state in which an underbody is released from an upper body and separated by a body fastening part in a coupling structure of a vehicle, according to an exemplary embodiment of the present disclosure, when the magnetic force is released.

FIG. 15 illustrates a plan view showing a state in which an underbody is released from an upper body and separated by a body fastening part in a state in which a magnetic force is released in a coupling structure of a vehicle, according to an exemplary embodiment of the present disclosure.

FIG. 16 illustrates a side view showing a body fastening part in a state where a magnetic force is released in a coupling structure of a vehicle, according to an exemplary embodiment of the present disclosure.

FIG. 17 illustrates a conceptual diagram showing a state of a switching magnet and magnetic force lines of a body fastening part in a state where a magnetic force is released in a coupling structure of a vehicle, according to an exemplary embodiment of the present disclosure.

FIG. 18 illustrates a side view showing a body fastening part in a state where magnetic force is generated in a coupling structure of a vehicle, according to an exemplary embodiment of the present disclosure.

FIG. 19 illustrates a conceptual diagram showing a switching magnet and magnetic force line state of a body fastening part in a state where a magnetic force is generated in a coupling structure of a vehicle, according to an exemplary embodiment of the present disclosure.

FIG. 20 illustrates a perspective view showing an upper body equipped with a stretcher leg in a folded state, viewed from below, in a combination structure of a vehicle, according to an exemplary embodiment of the present disclosure.

FIG. 21 illustrates a perspective view showing an upper body equipped with a stretcher leg in an unfolded state, viewed from below, in a combination structure of a vehicle, according to an exemplary embodiment of the present disclosure.

FIG. 22 illustrates a side view showing a state in which an underbody begins to enter a lower part of an upper body supported by a stretcher leg in a combination structure of a vehicle, according to an exemplary embodiment of the present disclosure.

FIG. 23 illustrates a side view showing a state in which an underbody begins to enter a lower part of an upper body supported by a stretcher leg in a combination structure of a vehicle, according to an exemplary embodiment of the present disclosure.

FIG. 24 illustrates a side view showing a state in which an underbody is inserted into a lower part of an upper body supported by a stretcher leg in a combination structure of a vehicle, according to an exemplary embodiment of the present disclosure.

FIG. 25 illustrates a side view showing an underbody having been completely inserted into a lower part of an upper body supported by a stretcher leg in a combined structure of a vehicle, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term "vehicle" or "vehicular" or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms "a," "an" and "the" are intended to include the plural forms as well, unless the context clearly indicates otherwise. These terms are merely intended to distinguish one component from another component, and the terms do not limit the nature, sequence or order of the constituent components. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

Further, in the embodiments, like reference numerals designate like elements throughout the specification representatively in a first embodiment, and only elements of other embodiments other than those of the first embodiment will be described.

The drawings are schematic and not proportionally scaled down. Relative scales and ratios in the drawings are enlarged or reduced for the purpose of accuracy and convenience, and the scales are random and not limited thereto. In addition, like reference numerals designate like structures, elements, or parts throughout the specification. It will be understood that when an element such as a layer, film, region, or substrate is referred to as being “on” another element, it can be directly on the other element or intervening elements may also be present.

Embodiments of the disclosure are described through schematic illustrations of idealized embodiments of the disclosure. As such, variations from the shapes of the illustrations as a result are to be expected. Thus, embodiments of the disclosure should not be construed to be limited to the particular shapes of regions illustrated herein but are to include deviations in shapes that result, for example, from manufacturing.

Hereinafter, with reference to the attached drawings, a coupling structure of a vehicle, according to an exemplary embodiment of the present disclosure, will be described in detail.

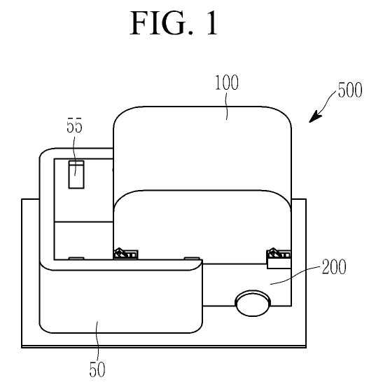

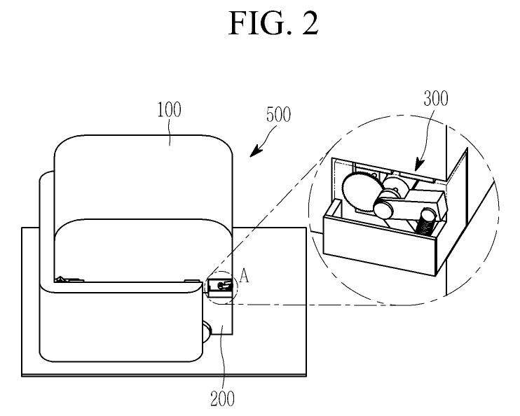

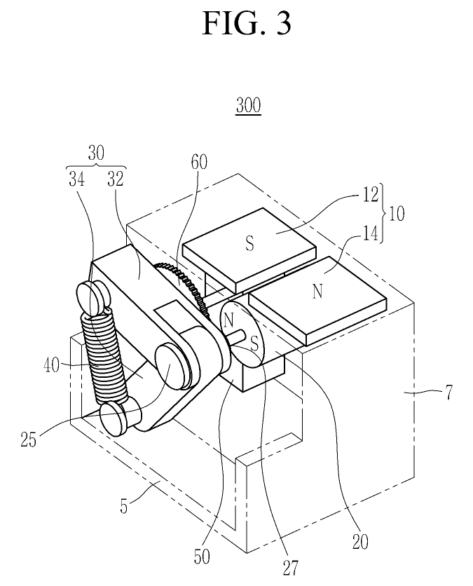

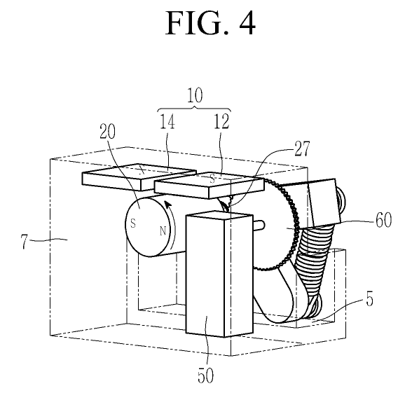

FIG. 1 illustrates a view showing a state in which a vehicle enters a placement station in a coupling structure of a vehicle, according to an exemplary embodiment of the present disclosure. FIG. 2 illustrates a view showing a state in which a vehicle has completed entry into a placement station in a coupling structure of a vehicle, according to an exemplary embodiment of the present disclosure. FIG. 3 illustrates a perspective view showing a body fastening part in a state where a magnetic force has disappeared, viewed from one side, in a coupling structure of a vehicle, according to an exemplary embodiment of the present disclosure. FIG. 4 illustrates a perspective view showing a body fastening part in a state where the magnetic force has disappeared, as viewed from the other side, in a coupling structure of a vehicle, according to an exemplary embodiment of the present disclosure.

Referring to FIGS. 1 and 2, the vehicle 500 may comprise a purpose-built vehicle (PBV) comprising a driving module and a space module coupled to the upper portion of the driving module. The driving module may be equipped with a driving device and be capable of autonomous driving, and the space module may be configured to be used for a cargo transport, a passenger transport, and a home office. The driving module and the space module may be connected to each other in the vertical direction and, when being separated from each, the driving module may be configured to run alone.

According to an exemplary embodiment of the present disclosure, an underbody 200 may constitute the driving module, and an upper body 100 may constitute the space module. The underbody 200 and the upper body 100 may be formed in a rectangular parallelepiped shape and may be joined at four corresponding corners.

As shown in FIGS. 1 and 2, with the upper body 100 and the underbody 200 combined, the vehicle may be configured to enter a charging station 150 and be charged. The underbody 200 and the upper body 100 may be configured to be fastened or unfastened by a body fastening part 300. The body fastening part 300 may be provided in four pieces at the corner portions of the lower part of the upper body 100.

As shown in FIGS. 3 and 4, the body fastening part 300 may be composed of a bracket 5 and 7, a switching magnet 10 and 20, a fastening switch 30, a motor 50, and a spring 40.

The bracket 5 and 7 may be provided at the lower corner portion of the upper body 100, and may be divided into a portion 7 that is recessed and positioned on the inside of the upper body 100 and a portion 5 that protrudes on the outside of the upper body 100.

The switching magnet 10 and 20 and the motor 50 may be positioned in the portion 7 that is recessed into the inner side of the upper body 100 of the bracket 5 and 7, and the fastening switch 30 and the spring 40 may be positioned in the portion 5 that protrudes outward from the upper body 100.

The switching magnet 10 and 20 may be configured and built into the bracket 5 and 7 and operate to fasten or separate the upper body 100 and the under body 200 depending on the change in the position of the polarity.

The switching magnet 10 and 20 may comprise an upper switching magnet 10 and a lower switching magnet 20.

The upper switching magnet 10 may be arranged in a horizontal direction with respect to the underbody 200 and may be provided with opposite polarities on one side and the other side. The upper switching magnet 10 may be formed in a plate shape and may be formed of a plurality of magnets arranged side by side with a gap between them.

In addition, the lower switching magnet may be is arranged to form the gap with the upper switching magnet 10, and may be provided with opposite polarities on one side and the other side, and may shaft-rotate by the driving of the motor 50. The lower switching magnet 20 may be formed in a cylindrical shape.

The fastening switch 30 may be connected to the switching magnets 10 and 20 and rotate to change the range of the magnetic force lines formed by the interaction of the switching magnets 10 and 20.

The fastening switch 30 may comprise an upper fastening switch 32 and a lower fastening switch 34. Each end of the upper fastening switch 32 and the lower fastening switch 34 may be connected to each other so that they may be rotated. Additionally, both ends of the spring 40 may be connected to the unconnected ends.

The spring 40 may be connected at both ends to both ends of the fastening switch 30, and may operate to apply a tension to the fastening switch 30 so that the fastening switch 30 may rotate and be fixed smoothly.

The upper fastening switch 32 may have one end connected to one end of the spring 40 and the other end connected to the rotation shaft of the motor 50. The other end of the upper fastening switch 32 may be configured to rotate in synchronization with the driving of the motor 50.

The lower fastening switch 34 may have one end superimposed and connected to the other end of the upper fastening switch 32, and the other end may be connected to the other end of the spring 40. When the other end of the upper fastening switch 32 rotates in synchronization with the driving of the motor 50, one end of the lower fastening switch 34 overlapping and connected thereto may be configured to rotate in the opposite direction to the rotation direction of the other end of the upper fastening switch 32. Therefore, the driving of the motor 50 may change the distance between one end of the upper fastening switch 32 and the other end of the lower fastening switch 34, which consequently changes the length and tension of the spring 40.

The other end of the upper fastening switch 32 and one end of the lower fastening switch 34 may be overlapped and connected by a rotary pin 25. The rotary pin 25 may be coaxially connected to the rotary axis of the lower switching magnet 20.

The motor 50 may be shaft-connected to the fastening switch 30 and may be configured to provide a power to rotate the fastening switch 30. The motor gear 60 may be coaxially connected to the rotation axis of the motor 50. The motor gear 60 may be in the shape of a disk, and gear teeth are formed on the edge portion.

The motor gear 60 may be connected to the lower switching magnet 20, so that when the motor 50 rotates, the motor gear 60 rotates, and thus the lower switching magnet 20 may rotate. For this purpose, a lower switching magnet gear 27 that rotates by meshing with the gear teeth of the motor gear 60 may be provided on the central rotation axis of the lower switching magnet 20. The rotation direction of the motor shaft and the rotation direction of the lower switching magnet 20 are formed oppositely.

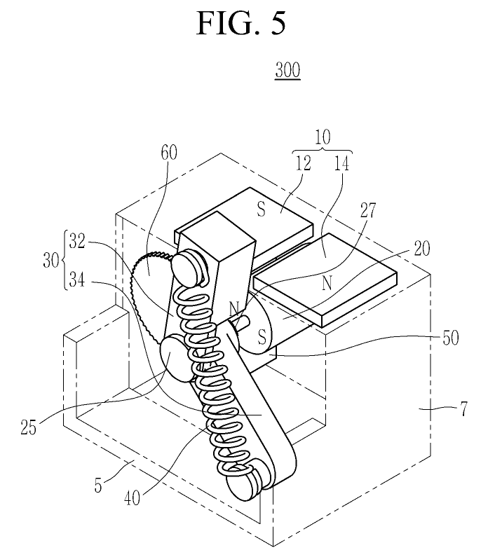

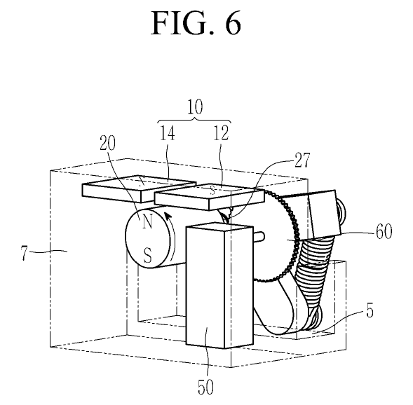

FIG. 5 illustrates a perspective view showing a body fastening part in a state where a magnetic force begins to be generated, as viewed from one side, in a coupling structure of a vehicle according to an exemplary embodiment of the present disclosure, and FIG. 6 illustrates a perspective view showing a body fastening part in a state where magnetic force begins to be generated, as viewed from the other side, in a coupling structure of a vehicle, according to an exemplary embodiment of the present disclosure.

As shown in FIGS. 5 and 6, when the motor 50 is driven and the motor shaft rotates, the motor gear 60 connected to the motor shaft rotates. Then, the lower switching magnet gear 27 gear-coupled to the motor gear 60 rotates, causing the lower switching magnet 20 to rotate about the axis thereof.

The arrangement and polarity of the upper switching magnet 10 may be fixed, and the lower switching magnet 20 may be rotated so that the edge portion where the polarity is formed is arranged in the vertical direction. Since the polarity of the lower switching magnet 20 is formed to be greater than the polarity of the upper switching magnet 10, in this case, a magnetic force line begins to be generated between the upper switching magnet 10 and the lower switching magnet 20. Additionally, an attractive force begins to occur between the upper body 100 and the under body 200 due to the magnetic force lines between the upper switching magnet 20 and the lower switching magnet 20.

Meanwhile, when the motor gear 60 and the lower switching magnet gear 27 are rotated by the driving of the motor 50, the rotary pin 300 to which the lower switching magnet gear 27 is connected rotates, and the lower fastening switch 34 connected to the rotary pin 25 may rotate. Additionally, the upper fastening switch 32, whose end is overlapped and connected to the lower fastening switch 34, may be rotated. The lower fastening switch 34 and the upper fastening switch 32 rotate in opposite directions, so that the other end of the lower fastening switch 34 and one end of the upper fastening switch 32 move away from each other. Accordingly, each spring of which has both ends connected to one end of the upper fastening switch 32 and the other end of the lower fastening switch 34, are tensioned.

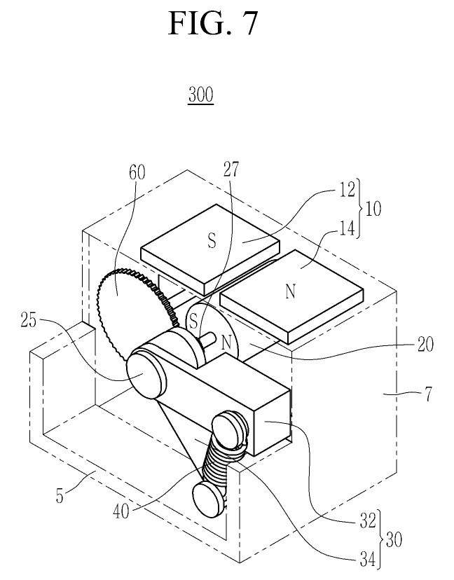

Additionally, the lower fastening switch 34 may rotate, and simultaneously the other end of the lower fastening switch 34 may move horizontally on the upper surface of the bracket 5, and FIG. 7 is a perspective view showing a body fastening part in a state where a magnetic force is generated, viewed from one side, in a coupling structure of a vehicle, according to an exemplary embodiment of the present disclosure.

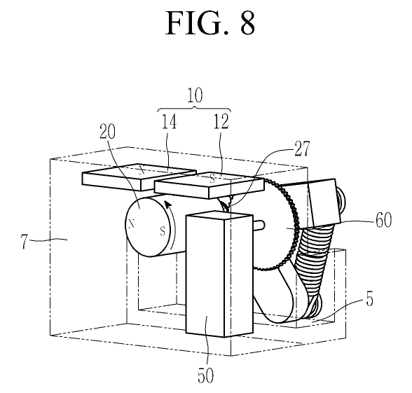

As shown in FIGS. 7 and 8, when the motor 50 continues to drive and the motor shaft rotates, the motor gear 60 and the lower switching magnet gear 27 may rotate further, and the lower switching magnet 20 may rotate further.

The arrangement and polarity of the upper switching magnet 10 may be fixed, and the lower switching magnet 20 is rotated so that the edge portion where the polarity is formed is arranged in the horizontal direction. At this time, the polarity of the upper switching magnet 10 and the polarity of the lower switching magnet 20 have the same polarity on the vertical line.

Since the polarity of the lower switching magnet 20 is formed to be greater than the polarity of the upper switching magnet 10, in this case, the maximum magnetic force line may be generated between the upper switching magnet 10 and the lower switching magnet 20, and the maximum attractive force may be formed between the upper body 100 and the underbody 200 by this magnetic force line.

Meanwhile, when the motor gear 60 and the lower switching magnet gear 27 are rotated by the driving of the motor 50, the rotary pin 25 to which the lower switching magnet gear 27 is connected may rotate, the lower fastening switch 34 connected to the rotary pin 25 may rotate, and the upper fastening switch 32 also may rotate. Additionally, the other end of the lower fastening switch 34 may also move horizontally.

At this time, the lower fastening switch 34 and the upper fastening switch 32 may be arranged to be close again. Accordingly, the spring of which both ends are connected to one end of the upper fastening switch 32 and the other end of the lower fastening switch 34 returns to the original state thereof.

As described above, the application and release of attraction force by the movement of the switching magnets 10 and 20 and the fastening switch 30 is described as being performed by the driving of the motor 50, but may also be performed by manually operating the upper fastening switch 32 without using the motor 50.

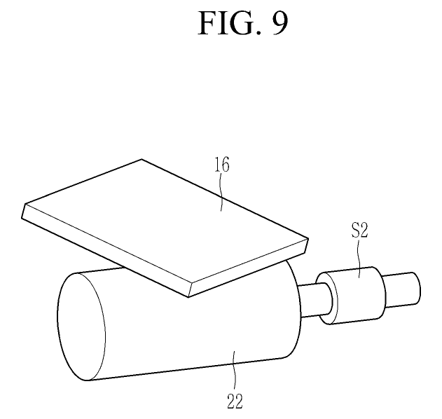

FIG. 9 illustrates a view showing another example of a switching magnet included in a body fastening part in a coupling structure of a vehicle, according to an exemplary embodiment of the present disclosure.

As shown in FIG. 9, the rotation axis of the motor S2 may be coaxially connected with the rotation axis of the lower switching magnet 22. In this case, since the motor gear and the lower switching magnet gear do not exist and the rotation axis of the lower switching magnet 22 is directly connected to the motor shaft, the motor shaft and the axial rotation directions of the lower switching magnet 22 may be formed to be the same. Meanwhile, the upper switching magnet 16 may be in the shape of a single plate. The polarities of one end and the other end of the upper switching magnet 16 may be formed in opposite directions.

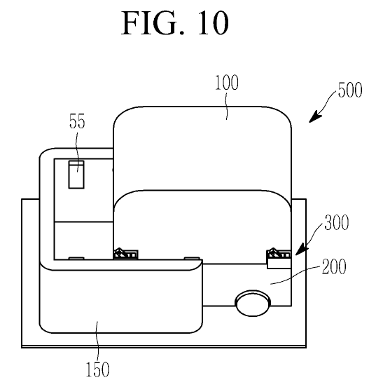

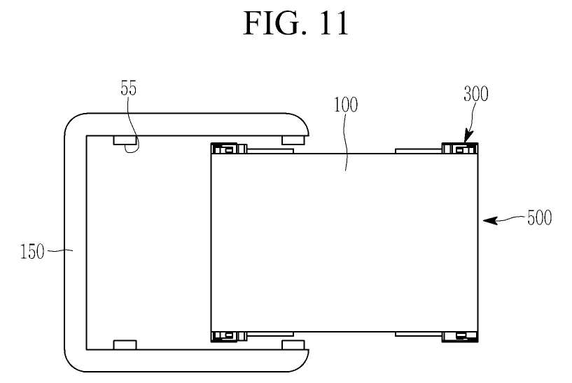

FIG. 10 illustrates a perspective view showing a state in which a vehicle, in which an upper body is coupled to an underbody by a body fastening part in a state in which a magnetic force is generated, enters a placement station in a coupling structure of a vehicle, according to an exemplary embodiment of the present disclosure. FIG. 11 illustrates a plan view showing a state in which a vehicle, in which an upper body is coupled to an underbody by a body fastening part in a state in which a magnetic force is generated, enters a placement station, as viewed from above, in a coupling structure of a vehicle, according to an exemplary embodiment of the present disclosure.

Referring to FIGS. 10 and 11, with the underbody 200 and the upper body 100 coupled by the body fastening part 300, the vehicle 50 begins to enter the placement station 150. At this time, the switching magnets 10 and 20 of the body fastening part 300 has the maximum range of the magnetic force lines formed. That is, the upper switching magnet 10 and the lower switching magnet 20 may have the same polarity on the vertical line, and the maximum range of the magnetic force lines may be generated between the upper switching magnet 10 and the lower switching magnet 20, and the maximum attractive force may be formed.

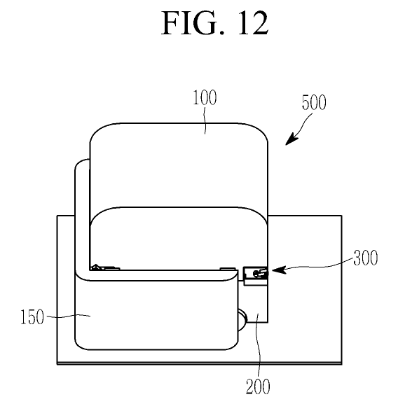

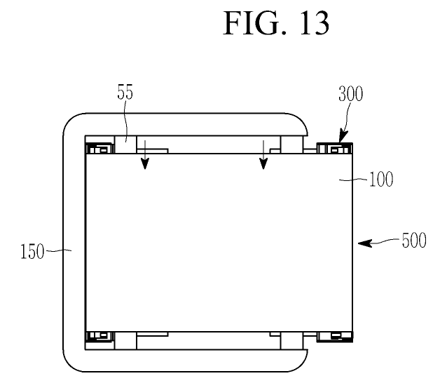

FIG. 12 illustrates a perspective view showing a state in which a vehicle, in which an upper body is coupled to an underbody by a body fastening part in a state in which a magnetic force is generated, has entered a placement station in a coupling structure of a vehicle, according to an exemplary embodiment of the present disclosure. FIG. 13 illustrates a plan view showing a state in which a vehicle, in which an upper body is connected to an underbody by a body fastening part in a state in which a magnetic force is generated, has entered a placement station, as viewed from above, in a coupling structure of a vehicle, according to an exemplary embodiment of the present disclosure.

Referring to FIGS. 12 and 13, the vehicle 500 enters the placement station 150 with the underbody 200 and the upper body 100 coupled by the body fastening part 300. At this time, the switching magnets 10 and 20 of the body fastening part 300 is in the state of forming the magnetic force line of the maximum range.

The upper body 100 may be mounted and fixed on the inside of the placement station 150. On the inside of the placement station 150, a protrusion (55) for fixing the PBV body may be formed to protrude toward the PBV body 100. Additionally, an upper body fixing groove may be formed on the side of the PBV body 100 and 200 so as to correspond to the position of the PBV body fixing protrusion 55.

The PBV body fixing protrusion 55 may be formed to correspond to the upper body 100 or the under body 200 of the PBV vehicle, and the corresponding fixing groove on the PBV body side may be formed in the PBV upper body 100 or the under body 200.

The vehicle 500 enters the placement station 150, and the upper body 100 may be fixed to the inside of the placement station 150 by the combination of the PBV body fixing protrusion 55 and the upper body fixing groove.

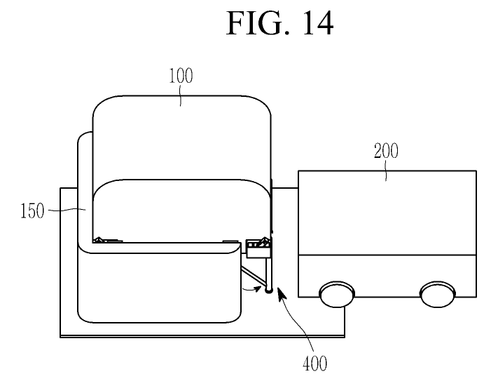

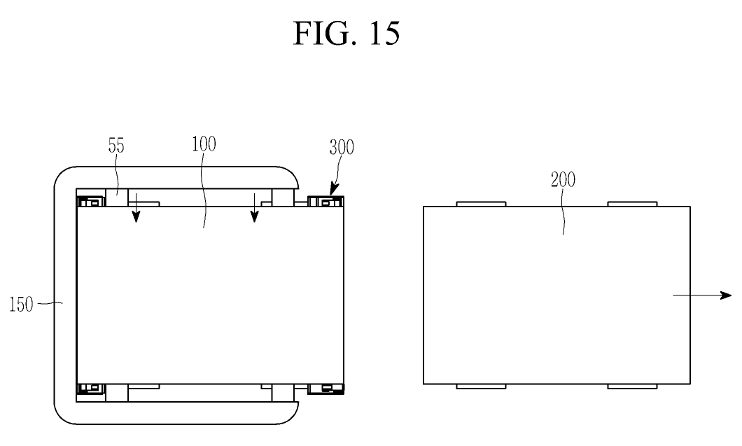

FIG. 14 illustrates a perspective view showing a state in which an underbody is released from an upper body and separated by a body fastening part in a coupling structure of a vehicle, according to an exemplary embodiment of the present disclosure, when the magnetic force is released. FIG. 15 illustrates a plan view showing a state in which an underbody is released from an upper body and separated by a body fastening part in a state in which a magnetic force is released in a coupling structure of a vehicle, according to an exemplary embodiment of the present disclosure.

Referring to FIGS. 14 and 15, the range of the magnetic force lines of the switching magnets 10 and 20 of the body fastening part 300 is reduced, the attractive force between the underbody 200 and the upper body 100 is released, and they are unfastened from each other. The upper body 100 may be fixedly mounted on the inside of the placement station 150, and the under body 200 may be separated from the upper body 100 and removed from the placement station 150 for works such as a replacement.

At this time, the underbody 200 may be released from the upper body 100, and at the same time, the stretcher leg 400 provided on the lower surface of the upper body 100 may be spread downward.

The lower surface of the upper body 100 may be provided with a plurality of stretcher legs 400 that operate to be folded or unfolded. In the state that the underbody 200 and the upper body 100 are coupled, when the stretcher leg 400 is folded and when the underbody 200 is detached from the placement station 150, the stretcher leg 400 may be unfolded to support the upper body 200 on the ground.

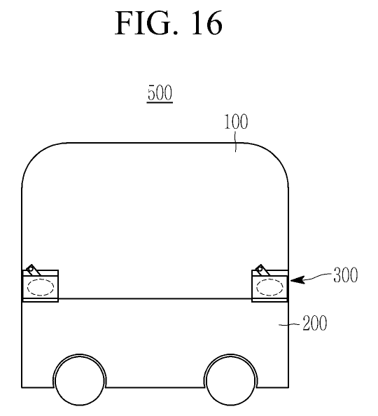

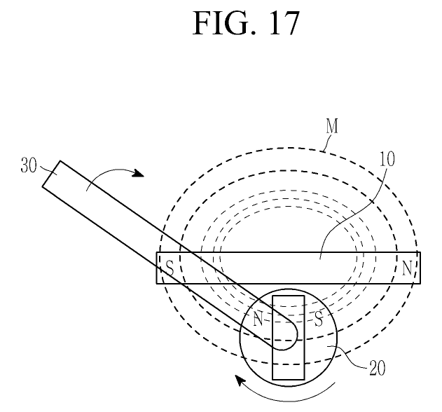

FIG. 16 illustrates a side view showing a body fastening part in a state where a magnetic force is released in a coupling structure of a vehicle, according to an exemplary embodiment of the present disclosure. FIG. 17 illustrates a conceptual diagram showing a state of a switching magnet and magnetic force lines of a body fastening part in a state where a magnetic force is released in a coupling structure of a vehicle, according to an exemplary embodiment of the present disclosure.

As shown in FIGS. 16 and 17, in order to release the coupling between the upper body 100 and the underbody 200, the range of the magnetic force lines of the body fastening part 300 is reduced, and the upper switching magnet 10 and the lower switching magnet 20 are positioned to have the opposite polarities on the vertical line, so that the range of the magnetic force lines is in a short range up and down, and thus no attractive force is generated between the upper body 100 and the underbody 100.

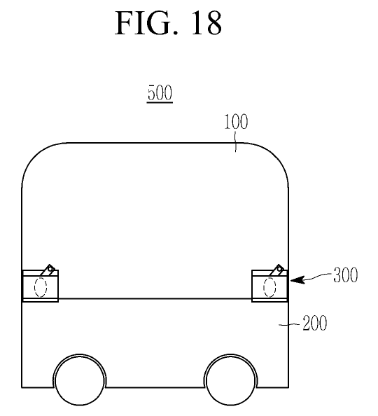

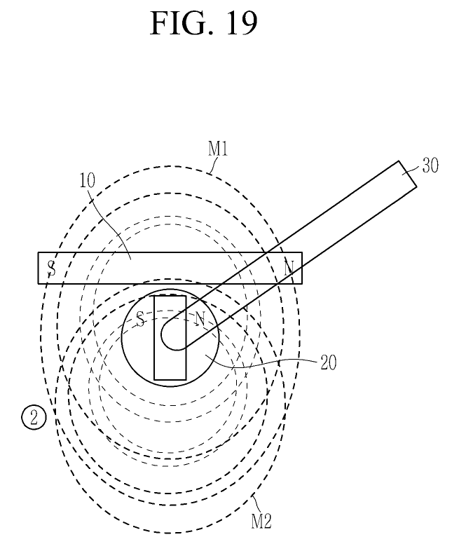

FIG. 18 illustrates a side view showing a body fastening part in a state where magnetic force is generated in a coupling structure of a vehicle, according to an exemplary embodiment of the present disclosure. FIG. 19 illustrates a conceptual diagram showing a switching magnet and magnetic force line state of a body fastening part in a state where a magnetic force is generated in a coupling structure of a vehicle, according to an exemplary embodiment of the present disclosure.

As shown in FIGS. 18 and 19, in order to fasten the upper body 100 and the underbody 200, the range of the magnetic force lines of the body fastening part 300 is maximized, and the upper switching magnet 10 and the lower switching magnet 20 are positioned to have the same polarity on the vertical line, so that the range of the magnetic force lines is in the maximum range up and down, and thus the maximum attractive force is generated between the upper body 100 and the underbody 200.

A paramagnetic iron plate on which the magnetic force of the switching magnet 10 and 20 acts may be provided in the underbody 200 portion corresponding to the body fastening part 300. The magnetic force lines may be extended to the paramagnetic iron plate to generate the attractive force between the upper body 100 and the underbody 200.

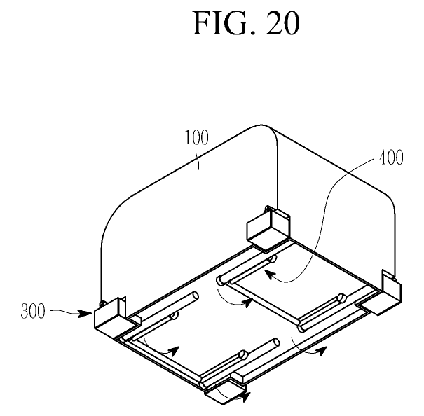

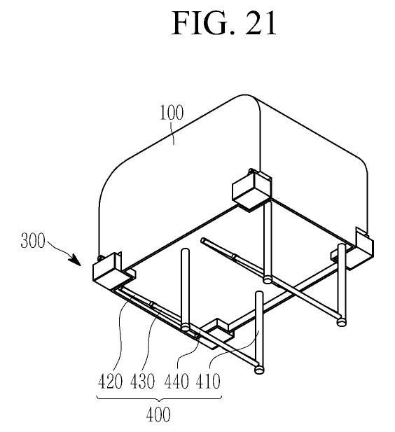

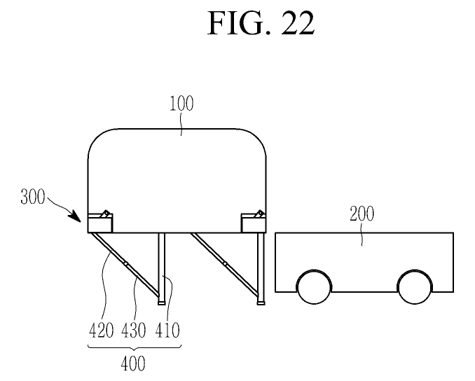

FIG. 20 illustrates a perspective view showing an upper body equipped with a stretcher leg in a folded state, viewed from below, in a combination structure of a vehicle, according to an exemplary embodiment of the present disclosure. FIG. 21 illustrates a perspective view showing an upper body equipped with a stretcher leg in an unfolded state, viewed from below, in a combination structure of a vehicle, according to an exemplary embodiment of the present disclosure. FIG. 22 illustrates a side view showing a state in which an underbody begins to enter a lower part of an upper body supported by a stretcher leg in a combination structure of a vehicle, according to an exemplary embodiment of the present disclosure.

Referring to FIGS. 20-22, the lower surface of the upper body 100 may be provided with a plurality of stretcher legs 400 that operate to be folded or unfolded. In the state where the underbody 200 and the upper body 100 are fastened, when the stretcher leg 400 may be folded, and the underbody 200 is detached from the placement station 150, the stretcher leg 400 may be unfolded to support the upper body 200 on the ground.

The stretcher leg 400 may comprise a first leg 410, a second leg 420, a first connection leg 430, and a second connection leg 440.

The first leg 410 may be connected so that one end may rotate in a direction perpendicular to the ground on the lower surface of the upper body 100, and the second leg 420 may be connected so that one end may rotate in a direction opposite to the rotation direction of the first leg 410 on the lower surface of the upper body 100.

The first connecting leg 430 may be configured to connect the other end of the first leg 410 and the other end of the second leg 420 so that the stretcher leg 400 may be folded or unfolded when the first leg 410 and the second leg 420 rotate, and the second connecting leg 440 may be configured to connect the other ends of the first legs 410 provided on the lower surfaces on both sides of the upper body 100.

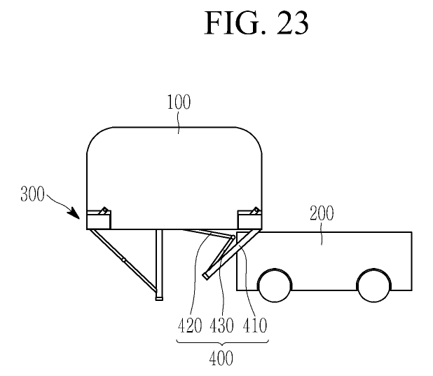

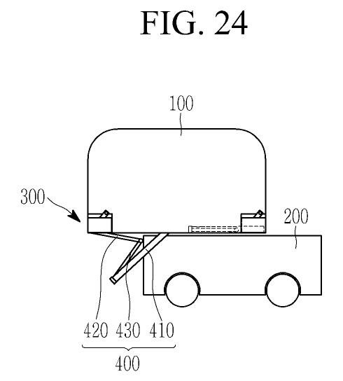

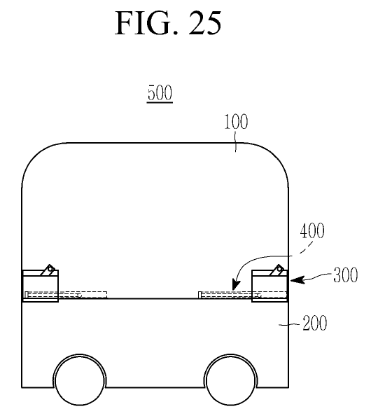

FIG. 23 illustrates a side view showing a state in which an underbody begins to enter a lower part of an upper body supported by a stretcher leg in a combination structure of a vehicle, according to an exemplary embodiment of the present disclosure. FIG. 24 illustrates a side view showing a state in which an underbody is inserted into a lower part of an upper body supported by a stretcher leg in a combination structure of a vehicle, according to an exemplary embodiment of the present disclosure. FIG. 25 illustrates a side view showing an underbody having been completely inserted into a lower part of an upper body supported by a stretcher leg in a combined structure of a vehicle, according to an exemplary embodiment of the present disclosure.

As illustrated in FIG. 23, when the underbody 200 begins to enter the lower part of the upper body 100, the stretcher leg 400 on the entry side comes into contact with the upper part of the underbody 200 and is folded. At this time, as the first leg 410 is pushed out, the second leg 420 and the first connecting leg 430 are folded while turning in the opposite directions.

As shown in FIG. 24, when the underbody 200 enters further into the lower part of the upper body 100, the stretcher leg 400 on the entry side is completely folded, and the stretcher leg 400 on the inner side also begins to fold.

As illustrated in FIG. 25, when the underbody 200 completes entering the lower part of the upper body 100, the stretcher legs 400 are all completely folded, and for the underbody 200 and the upper body 100 to be completely fastened, the body fastening part 300 changes the range of the magnetic force lines by changing the position of the switching magnets 10 and 20, thereby the attractive force acts between the underbody 200 and the upper body 100.

In this way, according to an exemplary embodiment of the present disclosure, in a body swap station of an unmanned delivery vehicle, by applying a lifting process of the upper body using the switching magnet when the fastening force between the upper body and the underbody of the vehicle is released, the swap process of the underbody may be performed quickly and easily.

Additionally, compared to a mechanical fastening between the upper body and the underbody, a noise during the fastening may be reduced and a robustness may be secured.

In addition, by changing the magnetic field lines of the switching magnet through the rotational motion of the fastening switch using the motor to utilize the principle of applying and releasing the attractive force, there is the effect of reducing the power consumption compared to when using an electromagnet.

In addition, by applying the foldable stretcher leg installed at the lower part of the upper body, the stable placement of the upper body on the inside of the placement station is possible during the swap process of the upper body and the under body.

While this disclosure has been described in connection with what is presently considered to be practical embodiments, it is to be understood that the disclosure is not limited to the disclosed embodiments.

What is claimed is:

1. A coupling structure of a vehicle, comprising:
an underbody constituting a driving module;
an upper body coupled to an upper portion of the underbody and constituting a space module; and
a body fastening part configured to fasten or unfasten the underbody and the upper body,
wherein the body fastening part comprises:
a bracket provided at a corner portion of the lower portion of the upper body;
a switching magnet built into the bracket and configured to fasten or unfasten the upper body and the under body according to a change in a position of polarity;
a fastening switch connected to the switching magnet and configured to rotate to change a range of magnetic force lines formed by the switching magnet;
a motor, shaft-connected to the fastening switch, configured to provide power to rotate the fastening switch; and
a spring having two ends connected to two ends of the fastening switch and configured to apply a tension to the fastening switch to enable a smooth rotation and fixation of the fastening switch.

2. The coupling structure of the vehicle of claim 1, wherein the switching magnet comprises:
an upper switching magnet arranged in a horizontal direction with respect to the underbody and having opposite polarities on one side and another side; and
a lower switching magnet arranged to form a gap with the upper switching magnet, having opposite polarities on one side and another side, and configured to rotate on an axis by the driving of the motor.

3. The coupling structure of the vehicle of claim 2, wherein:
the upper switching magnet is formed in a plate shape, and
the lower switching magnet is formed in a cylindrical shape.

4. The coupling structure of the vehicle of claim 3, wherein the upper switching magnet is formed of a plurality of plate shapes that form a gap between each other.

5. The coupling structure of the vehicle of claim 3, wherein the rotation axis of the motor is coaxially connected to the rotation axis of the lower switching magnet.

6. The coupling structure of the vehicle of claim 3, wherein the rotation axis of the motor further comprises a motor gear coaxially connected to the rotational axis of the motor and coupled to the switching magnet to rotate the switching magnet.

7. The coupling structure of the vehicle of claim 2, wherein:
the fastening switch comprises:
an upper fastening switch having one end connected to one end of the spring and the other end connected to the rotational shaft of the motor so as to rotate in synchronization with the driving of the motor; and
a lower fastening switch having one end overlapping and connected to the other end of the upper fastening switch and the other end connected to the other end of the spring, and
a distance between one end of the upper fastening switch and another end of the lower fastening switch changes as they rotate around a portion where the other end of the upper fastening switch and one end of the lower fastening switch overlap.

8. The coupling structure of the vehicle of claim 7, wherein:
the other end of the upper fastening switch and one end of the lower fastening switch are coupled by a rotary pin, and
the rotary pin is coaxially connected to the rotation axis of the lower switching magnet.

9. The coupling structure of the vehicle of claim 8, wherein:
when the distance between one end of the upper fastening switch and the other end of the lower fastening switch rotate to be increased, the spring is tensioned, and
when a restoring force is applied, the distance between one end of the upper fastening switch and the other end of the lower fastening switch is reduced by an elasticity of the spring.

10. The coupling structure of the vehicle of claim 2, wherein a polarity of the lower switching magnet is formed to be larger than a polarity of the upper switching magnet.

11. The coupling structure of the vehicle of claim 10, wherein the polarities of the upper switching magnet and the lower switching magnet are facing upward and downward and are formed opposite to each other while the distance between one end of the upper fastening switch and the other end of the lower fastening switch is rotated toward one side as close as possible.

12. The coupling structure of the vehicle of claim 11, wherein the magnetic force lines of the switching magnet are formed only within the upper body when the polarities of the upper switching magnet and the lower switching magnet facing each other are formed in opposite directions.

13. The coupling structure of the vehicle of claim 12, wherein the polarities of the upper switching magnet and the lower switching magnet, facing upward and downward, are formed to be the same while the distance between one end of the upper fastening switch and the other end of the lower fastening switch is rotated toward the other side as close as possible.

14. The coupling structure of the vehicle of claim 13, wherein:
when the polarities of the upper switching magnet and the lower switching magnet facing each other are formed to be the same, the magnetic force lines of the switching magnet are formed to extend from the side of the upper body to the under body, and
in the underbody portion corresponding to the body fastening portion, a paramagnetic iron plate on which an attractive force is applied by the magnetic force lines of the switching magnet is provided.

15. The coupling structure of the vehicle of claim 1, wherein:
the vehicle is placed inside the placement station in a state where the underbody and upper body are fastened, and
the upper body is fixedly mounted on the inside of the placement station while the underbody and upper body are separated from each other, and the underbody is detached from the placement station.

16. The coupling structure of the vehicle of claim 15, wherein, when the upper body is placed and fixed on the inside of the placement station:
a PBV body fixing protrusion protrudes toward the upper body on the inside of the placement station, and
the PBV body fixing protrusion is inserted into an upper body fixing groove formed corresponding to the side of the upper body.

17. The coupling structure of the vehicle of claim 15, wherein:
the lower surface of the upper body is provided with a plurality of stretcher legs that operate to be folded or unfolded,
with the underbody and the upper body fastened, the stretcher leg is folded, and
the stretcher legs are spread out to support the upper body on the ground when the underbody is detached from the placement station.

18. The coupling structure of the vehicle of claim 17, wherein the stretcher leg comprises:
a first leg having one end connected to the lower surface of the upper body so as to rotate in a direction perpendicular to the ground;
a second leg having one end connected to the lower surface of the upper body so as to rotate in the opposite direction to the rotation direction of the first leg; and
a first connecting leg that connects the other end of the first leg and the other end of the second leg so that the stretcher leg may be folded or unfolded when the first leg and the second leg are rotated.

19. The coupling structure of the vehicle of claim 18, wherein the stretcher leg further comprises a second connecting leg connecting the other ends of the first legs provided on the lower surfaces on both sides of the upper body.

20. A coupling structure of a vehicle, comprising:
a body fastening part configured to fasten or unfasten an underbody and an upper body,
wherein:
the underbody constitutes a driving module,
the upper body is coupled to an upper portion of the underbody and constitutes a space module, and
the body fastening part comprises:
a bracket provided at a corner portion of the lower portion of the upper body;
a switching magnet built into the bracket and configured to fasten or unfasten the upper body and the under body according to a change in a position of polarity;
a fastening switch connected to the switching magnet and configured to rotate to change a range of magnetic force lines formed by the switching magnet;
a motor, shaft-connected to the fastening switch, configured to provide power to rotate the fastening switch; and
a spring having two ends connected to two ends of the fastening switch and configured to apply a tension to the fastening switch to enable a smooth rotation and fixation of the fastening switch.
